(19) United States
(12) Patent Application Publication
(10) Pub. No.: US 2006/0159826 A1
(43) Pub. Date: Jul. 20, 2006

(54) Soy protein for infant formula

(76) Inventor: Theodore M. Wong, Ballwin, MO (US)

Correspondence Address: SOLAE, LLC, PO BOX 88940, ST LOUIS, MO, 63188, US

(21) Appl. No.: 11/330,589

(22) Filed: Jan. 12, 2006

Related U.S. Application Data
(60) Provisional application No. 60/644,266, filed on Jan. 14, 2005.

(51) Int. Cl. A23L 2/00

(52) U.S. Cl. 426/590

(57) ABSTRACT

The present invention is directed to a nutritional formula for feeding human infants comprising isolated soy protein wherein the isolated soy protein has (a) a degree of hydrolysis of from about 0.5% up to about 30%; (b) a combination of an inositol-6-phosphate content, an inositol-5-phosphate content, an inositol-4-phosphate content and an inositol-3-phosphate content of less than about 8.0 μmol/g soy protein on a moisture free basis; and (c) a nitrite content of less than about 10 parts per million. Optionally, the isolated soy protein for the nutritional formula has a free amino acid content of up to about 25%. Further, the isolated soy protein for the nutritional formula optionally has a calcium content of from about 1.0% up to about 12%.

### FIELD OF THE INVENTION

The present invention relates to infant formula compositions comprising isolated soy protein and methods of feeding infants with such a formula. The soy protein employed is partially hydrolyzed, has a low phytic acid content of inositol-6-phosphate, inositol-5-phosphate, inositol-4-phosphate and inositol-3-phosphate, has an extremely low nitrite content, and has a free amino acid content.

### BACKGROUND OF THE INVENTION

Many food and beverage products include protein supplements derived from vegetable materials such as soybeans, beans, peas, other legumes, and oilseeds such as rapeseed. Vegetable protein materials, particularly soy, are used to fortify infant formulas. The purpose of the vegetable protein supplement in an infant formula is to increase the nutritional value of the formula, and to provide a protein content approximate to the protein content of human milk.

Commercially available protein concentrates and isolates, however, contain some impurities which are undesirable in products such as infant formulas. Specific impurities which are undesirable in vegetable protein isolates and concentrates include phytic acid, phytates, ribonucleic acids, ash, and minerals bound to phytic acid, phytates, or ribonucleic acids which are unavailable for human assimilation such as phosphorus, calcium, chloride, iron, zinc, and copper. It is desirable to provide methods for reducing the levels of these impurities in vegetable protein isolates and concentrates, particularly for use in products such as infant formulas.

Reducing the level of phytic acid, also known as inositol hexaphosphoric acid, and phytates, which are the salts of phytic acid, in vegetable protein materials has been of interest since phytic acid and phytates tend to form complexes with proteins and multivalent metal cations, reducing the nutritional value of the vegetable protein material. Significant efforts have been made to reduce the concentration of phytic acid and phytates in vegetable protein materials. For example, U.S. Pat. No. 5,248,765 to Mazer et al. provides a method of separating phytate and manganese from protein and dietary fiber by treating an aqueous slurry of the phytate-containing material with alumina at low pH. The alumina, together with phytate attached to the alumina, is then separated from the protein and fiber material. U.S. Pat. No. 2,732,395 to Bolley et al., U.S. Pat. No. 4,072,670 to Goodnight et al., U.S. Pat. No. 4,088,795 to Goodnight et al., U.S. Pat. No. 4,091,120 to Goodnight et al., and U.K. Patent No. 1,574,110 to depham all teach various methods of removing phytic acid and phytates from protein materials by various precipitation and differential solubility separation techniques.

Soy-based infant formulas are lactose-free, vegetarian alternatives to milk-based infant formulas for infants. Soy-based infant formulas may also be fed to infants with intolerance to cow milk-based feedings.

Infant formulas represent the sole item of diet of many infants for the first months of life. This total nutritional dependency has stimulated efforts to improve the nutritional quality of soy-based infant formula products.

Early soy-based infant formulas were based on full-fat soy flour. However, it was found that the indigestible soy oligosaccharides raffinose and stachyose in soy flour led to excessive intestinal gas. In 1965, the first infant formula based on soy protein isolate, more accurately described as isolated soy protein, was introduced in the United States. Current soy-based infant formula products contain isolated soy protein (“ISP”) supplemented with the essential amino acid L-methionine as the protein source (see, eg, “Nutrition of Normal Infants,” edited by Fomon, p. 428, 1993).

Thirty percent of the essential mineral phosphorus in typical ISP is present as phytate. Phytate is a poor biologically available source of phosphorus. Accordingly, ISP-based infant formulas contain levels of total phosphorus approximately 20% higher than milk-based infant formulas because milk-based infant formulas contain no phytate and thus no phytate-phosphorus.

Phytate creates an additional nutritional disadvantage for soy-based infant formulas because phytate binds minerals, especially calcium and zinc, and reduces their biological availability. “Soy Protein-Based Formulas: Recommendations For Use In Infant Feeding”, Pediatrics, 1998; 101:148-153) indicates that the percentage of absorption of zinc from soy-based formula (14%) is about one-third of the percentage of absorption of zinc from breast milk (41%). As a consequence, ISP-based infant formulas are fortified at a higher level of zinc than are milk-based infant formulas. Therefore, it is postulated that a reduction in the phytate content will increase the bioavailability of minerals in an infant formula.

Consequently, a variety of methods for reducing or eliminating phytate from soy flour and ISP have been developed. For example, Ford et al. J. Am. Oil Chemists Soc., 55:371-374, (1978) disclose a process of adjusting the pH and calcium concentration during precipitation of the protein from full-fat soy flour to eliminate up to 90% of the phytate. U.S. Pat. No. 6,284,502 discloses a process for converting phytate in a food into inorganic phosphate, said process comprising mixing a slurry of the phytate-containing food with phytase enzyme. U.S. Pat. No. 6,313,273 discloses a method comprising treating a soy protein source with one or more enzymes possessing nuclease and phytase activity, followed by ultrafiltration and diafiltration to remove phytic acid, isoflavones and nucleic acids, to produce a soy protein with reduced levels of phytate, isoflavones and nucleic acids. Phytate levels are reduced by at least 50% and more preferably by about 70%. U.S. Pat. No. 5,248,804 discloses a process for the removal of phytate from protein using ion exchange. These and other processes for reducing or eliminating the phytate in soy proteins are known to those skilled in the art.

In addition to a reduction of phytic acid and phytates, soy protein can also be partially hydrolyzed to improve its utility for patients with compromised nutritional status. An increase in the degree of hydrolysis of the soy protein makes the soy protein more easily digestible. A variety of methods have been developed to hydrolyze soy protein. See, for example, U.S. Pat. No. 3,970,520 which discloses a method for treating isolate soy protein with proteolytic enzyme preparations to form soluble protein hydrolysates with molecular weights of 200 to 900 Daltons.

U.S. Pat. No. 4,100,024 discloses a method for producing soy hydrolysates with a reported degree of hydrolysis of 8% to 15%.

U.S. Pat. No. 4,443,540 discloses a method for preparing soluble, low molecular weight protein hydrolysates from soy protein isolate, by treating the protein material with proteolytic enzyme, followed by ultrafiltration to remove the protein hydrolysates in the permeate.

U.S. Pat. No. 6,126,973 discloses an enzymatic method to selectively hydrolyze the 7S globulin (beta-conglycinin) protein of soy. U.S. Pat. No. 6,303,178 discloses a polypeptide composition obtained by independently hydrolyzing the 7S component and the 11S component of soybean protein.

U.S. Pat. No. 6,221,423 discloses a composition produced by subjecting insoluble protein, preferably soy protein, to an enzyme preparation with substantial exopeptidase activity and substantial endopeptidase activity. The reported degrees of hydrolysis of the examples all exceed 10%.

### SUMMARY OF THE INVENTION

The present invention is directed to a nutritional formula for feeding human infants comprising isolated soy protein wherein the isolated soy protein has

(a) a degree of hydrolysis of from about 0.5% up to about 30%;

(b) a combination of an inositol-6-phosphate content, an inositol-5-phosphate content, an inositol-4-phosphate content and an inositol-3-phosphate content of less than about 8.0 μmol/g soy protein on a moisture free basis; and

(c) a nitrite content of less than about 10 parts per million.

Optionally, the isolated soy protein for the nutritional formula has a free amino acid content of up to about 25%. Further, the isolated soy protein for the nutritional formula optionally has a calcium content of from about 1.0% up to about 12%.

### DETAILED DESCRIPTION OF THE INVENTION

Isolated soy protein or “ISP,” refers to an unfortified composition which contains, on a moisture-free at least about 90% soy protein as measured using the Microkjeldahl method for determining nitrogen (AOAC (1975) “Official Methods of Analysis”, Section 47.021 Association of Official Analytical Chemists, Washington D.C.). The protein content is calculated from the nitrogen content using the conversion factor of 6.25.

When an ISP is fortified with an alkaline earth metal phosphate such as calcium phosphate, the soy protein is typically below a 90% content. This is due to a dilution effect.

Soy protein isolates are formed by extracting the soy protein material with an aqueous solution to solubilize protein material. The solubilized protein material extract is then separated from insoluble vegetable matter such as cellulose and other vegetable fibers. The pH of the protein extract is then adjusted to about the isoelectric point of the protein to precipitate the protein. The precipitated protein is separated from the solution by filtration or centrifugation to separate the protein material from water soluble carbohydrates, minerals, phenolics, and other non-proteinaceous materials which remain in the solution. The separated protein is then washed with water to form the protein isolate.

In the present invention, commercially available defatted soy flakes are utilized as the starting material. Preferably the soy flakes have been treated with a sulfite such as sodium sulfite for improved flow characteristics and improved microbial control. The soy flakes are extracted with an aqueous alkaline solution, preferably an aqueous sodium hydroxide solution, having a pH from about 8 up to about 11. Preferably the weight ratio of the extractant to the soy flake material is from about 5:1 to about 16:1. The extract is separated from the insoluble materials such as soy fiber and cellulose by filtration or by centrifugation and decantation of the supernatant extract from the insoluble materials. The pH of the separated extract is adjusted to about the isoelectric point of soy protein, preferably from about pH 4 to about pH 5, most preferably from about pH 4.4 to about pH 4.6, with a suitable acid, preferably hydrochloric acid, sulfuric acid, nitric acid, or acetic acid, to precipitate a soy protein material. The precipitated protein material is separated from the extract, preferably by centrifugation or filtration. The separated protein material is washed with water, preferably at a weight ratio of water to protein material of about 5:1 to about 12:1 to produce the soy protein isolate.

An aqueous slurry of the soy protein concentrate or soy protein isolate (hereinafter, generally, the “protein material”) is formed by mixing the protein material with water to form a slurry. Preferably the slurry should contain from about 2% to about 30% of the protein material by weight, and more preferably should contain from about 5% to about 20% of the protein material by weight, and most preferably should contain from about 10% to about 18% of the protein material by weight.

The slurry is then treated with an enzyme preparation containing an acid phosphatase (orthophosphoric monoester phosphohydrolase (I.U.B. 3.1.3.2)) at an acid phosphatase concentration, temperature, a pH, and for a time effective to substantially reduce the concentration of phytic acid and phytates. The enzyme preparation containing an acid phosphatase is derived from a microbial or fungal source such as the Aspergillus and Rhizopus species. A preferred source of the acid phosphatase useful in the method of the present invention is the Aspergillus niger fungus. Phytase enzyme preparations derived from Aspergillus niger and which contain acid phosphatase are commercially available.

The enzyme preparation degrades and reduces the concentration of phytic acid and phytates such that the inositol-6-phosphate content, inositol-5-phosphate content, inositol-4-phosphate content and inositol-3-phosphate content is less than about 8.0 μmol/g of soy protein on a moisture free basis, preferably less than about 6.0 μmol/g of soy protein on a moisture free basis and most preferably less than about 3.0 μmol/g of soy protein on a moisture free basis.

In order to effectively degrade the concentration of phytic acid, and phytates in the protein material, the enzyme preparation should include a sufficient amount of acid phosphatase, or a combination of acid phosphatase and another phytase such as 3-phytase(myo-inositol-hexakisphosphate 3-phosphohydrolase (I.U.B. 3.1.3.8)) to degrade the ribonucleic acids, phytic acid, and phytates. In a most preferred embodiment, the enzyme preparation is added so that the acid phosphatase and 3-phytase are present in the slurry from about 0.1% up to about 10% of the protein material by dry weight, more preferably from about 0.3% to about 5% of the protein material by dry weight, and most preferably from about 0.5% up to about 3% of the protein material by dry weight.

The enzyme preparation preferably has an activity from about 400 to about 1400 kilo phytase units per kilogram of protein solids (KPU/kg protein solid), more preferably has an activity of about 600 to about 1200 KPU/kg protein solid, and most preferably has an activity of about 1000 KPU/kg protein solid. A kilo phytase unit equals 1000 phytase units, where a phytase unit equals the quantity of enzyme which liberates one nanomole of inorganic phosphates from sodium phytate in one minute under standard conditions (40° C., pH 5.5, and 15 minutes incubation). The activity of the enzyme preparation includes acid phosphatase activity and the activity of any other phytase enzyme included in the enzyme preparation.

The pH of the slurry treated with the enzyme preparation should be a pH at which the enzyme preparation is effective to degrade phytic acid and phytates. It is known in the art that phytase enzymes very effectively degrade phytic acid and phytates at a pH of about 5.3. In a preferred embodiment, the pH of the slurry treated with the enzyme preparation is from about 3 to about 6, more preferably from about 3.5 to about 5.5, and even more preferably from about 4 to about 5, and most preferably from about 4.4 to about 4.6. The pH of the slurry may be adjusted with a suitable acidic reagent, such as hydrochloric acid, sulfuric acid, nitric acid, or acetic acid, or a suitable basic reagent, such as sodium hydroxide, calcium hydroxide or ammonium hydroxide, as necessary to obtain the desired pH.

The temperature of the slurry treated with the enzyme preparation should be a temperature at which the enzymes in the enzyme preparation are effective to degrade phytic acid and phytates. Preferably the temperature of the slurry should be high enough to maximize the enzymatic degradation of phytic acid, and phytates, but not high enough to inactivate the enzyme(s) or to degrade the protein material in the slurry. In a preferred embodiment, the temperature at which the slurry is treated with the enzyme preparation containing acid phosphatase is from about 20° C. to about 70° C., more preferably from about 30° C. to about 60° C., and most preferably from about 40° C. to about 55° C.

The time period which the slurry is treated with the enzyme preparation should be sufficient to enable the enzyme(s) to effectively degrade and reduce the concentration of the phytic acid and phytates in the soy protein material. Preferably the slurry is treated with the enzyme preparation at an effective pH and temperature from about 30 minutes to about 4 hours, more preferably from about 45 minutes to about 3 hours, and most preferably from about 1 hour to about 2 hours. The slurry may be washed and centrifuged to remove the degraded phytic acid and phytates.

The soy protein material is then reslurried in water and the vegetable protein material optionally is fortified with calcium phosphate, typically to a calcium content of from about 1% up to about 12%, preferably up to about 8% and most preferably up to about 3%. A method of calcium fortification is by the addition of an aqueous slurry of calcium phosphate.

Following treatment of the soy protein material slurry with the enzyme preparation and with the calcium fortification, the soy protein slurry is then subjected to a heat treatment step wherein the slurry is heated to (121±10)° C. and held at that temperature for about 9 seconds. This heat treatment is effectively a pasteurization step in that microbes that may reside in the vegetable slurry are killed. Additionally the enzyme preparation for the reduction of phytic acid and phytates is inactivated by this pasteurization.

The pasteurized slurry is then enzymatically hydrolyzed and deamidated under conditions that expose the proteins to enzymatic action. The resulting degree of hydrolysis, commonly expresses as % DH generally is from about 0.5% up to about 30%, preferably from about 5% up to about 20% and most preferably from about 10% up to about 15%. The enzyme of choice is a cysteine protease.

The procedure for determining % DH is the trinitrobenzenesulphonic acid (TNBS) procedure. This procedure is an accurate, reproducible and generally applicable procedure for determining the degree of hydrolysis of food protein hydrolyzates. The protein is dissolved/dispersed in hot 1% sodium dodecyl sulfate to a concentration of 0.25-2.5×10⁻³ aminoequivalents/L. A sample solution (0.25 ml) is mixed with 2 ml of 0.2125 M sodium phosphate buffer (pH 8.2) and 2 ml of 0.1% Trinitrobenzenesulphonic acid, followed by incubation in the dark for 60 minutes at 50° C. The reaction is quenched by adding 4 ml. of 0.10 N hydrochloric acid (HCl) and the absorbance is read at 340 nm. A 1.5 mM L-leucine solution is used as the standard. Transformation of the measured leucine amino equivalents to a degree of hydrolysis is carried out by means of a standard curve for each particular protein substrate (Adler Nissen, J. [1979] J. Agri. Food Chem. 27,6, 1256-1262).

Optionally, the isolated soy protein for the nutritional formula has a free amino acid content of up to about 25%. Further, amino acids are generated during processing such that the isolated soy protein has from about 1% up to about 20% of a free amino acid content on a moisture free basis, preferably from about 3% up to about 15% free amino acid on a moisture free basis and most preferably from about 5% up to about 10% free amino acid on a moisture free basis. Free amino acids are generated by the use of exopeptide enzymes.

The cysteine protease enzyme used for hydrolysis and the exopeptide enzyme used for the generation of free amino acids can be added at the same time to the procedure or can be added sequentially. When added at the same time, both enzymes are deactivated by a second pasteurization step at about (150° C.) for about 9 seconds. The deactivated slurry is homogenized to reduce the particle size of the slurry. Homogenization is conducted at about 3000 pounds per square inch.

The contents may be spray dried through indirect fire which gives a product having a nitrite content of less than about 10 parts per million, preferably less than about 8 parts per million and most preferably at less than about 4 parts per million.

When the cysteine protease enzyme and the exopeptide enzyme are added sequentially, the cysteine protease enzyme is added first. After the cysteine protease enzyme is deactivated as per the above procedure, the exopeptide enzyme is added followed by homogenization. The exopeptide enzyme is then deactivated by spray drying.

Typically spray drying of protein isolates is carried forth by direct fire. In the direct fire procedure, the protein slurry is sprayed into fine particles in a hot air stream to evaporate the water and dry the product. With a direct fired burner, fresh air is pulled into a dryer inlet duct. There is a natural gas burner in the inlet duct and the incoming protein slurry is heated by coming into direct contact with the flame. With direct fire, combustion products are not just carbon dioxide and water, but also include NOₓ which is NO and NO₂. These oxides of nitrogen dissolve in water to form nitrous and nitric acids and react with the calcium from fortification to generate nitrates and nitrites. For an indirect fired burner, the incoming air is passed over a series of sealed tubes in the dryer duct. A separate stream of air is heated using the direct fired method and passed through the inside of these tubes, heating the incoming fresh air. The incoming hot air to dry the product in the dryer never contacts the natural gas burner. Reducing the nitrite level of the soy protein isolate thus reduces nitrites intake.

The present formula may be in a liquid form, either as a ready-to-feed liquid or as a concentrated liquid requiring dilution with additional water before feeding, or in a powdered form requiring addition with water prior to use. The present infant formulas may be prepared by combining the isolated soy protein, one or more fats or oils, one or more sources of carbohydrate, amino acids, vitamins, minerals, and other nutrients and other substances known to those skilled in the art. See the Codex Standard for Infant Formula, CODEX STAN 72-1981 (amended 1983,1985, 1987), which is hereby incorporated by reference. The infant formulas of the present invention may contain one or more other ingredients known in the art to be useful in such nutritional formulations including but not limited to longer chain polyunsaturated fatty acids (U.S. Pat. No. 4,670,285, to Clandinin et al), ribonucleotides (U.S. Pat. No. 5,700,590, to Masor et al.), and oligosaccharides (U.S. Pat. No. 5,849,324, to Dohnalek).

The present invention is further directed to a method of feeding a human infant comprising administering to the human infant a nutritionally sufficient amount of an infant formula comprising an isolated soy protein wherein the isolated soy protein has

(a) a degree of hydrolysis of from about 0.5% up to about 30%;

(b) a combination of an inositol-6-phosphate content, an inositol-5-phosphate content, an inositol-4-phosphate content and an inositol-3-phosphate content of less than about 8.0 mmol/g soy protein on a moisture free basis; and

(c) a nitrite content of less than about 10 parts per million.

The nutritional formula useful in this method preferably comprise isolated soy protein having a phytate content such that the inositol-6-phosphate content, inositol-5-phosphate content, inositol-4-phosphate content and inositol-3-phosphate content is less than about 8.0 mmol/g, preferably less than about 6.0 pmol/g and most preferably less than about 3.0 mmol/g.

The nutritional formula useful in the present method contains isolated soy protein having a degree of hydrolysis generally from about 0.5% up to about 30%, preferably from about 5% up to about 20% and most preferably from about 10% up to about 15%.

Optionally, the isolated soy protein for the nutritional formula has a free amino acid content of up to 25%. Further, the nutritional formula useful in the present method generally has from about 1% up to about 20% of a free amino acid content on a moisture free basis, preferably from about 3% up to about 15% free amino acid on a moisture free basis and most preferably from about 5% up to about 10% free amino acid on a moisture free basis.

The present invention is illustrated by the following example which is merely for the purpose of illustration and not to be regarded as limiting the scope of the invention or manner in which it may be practiced.

### EXAMPLE 1

A purified vegetable protein isolate is formed in accordance with the process of the present invention. Two hundred forty-three pounds of a soy protein isolate is added to two thousand nine hundred and fifty-nine pounds of water to form a soy protein isolate slurry containing 7.6% solids. The pH of the slurry is adjusted to 4.5 with hydrochloric acid, and the temperature of the slurry is raised to 50° C. An enzyme preparation containing an acid phosphatase and a phytase and having an activity of 1000 KPU/kg of curd solids is added to the slurry. The slurry is treated with the enzyme preparation for two hours, after which the pH of the slurry is adjusted to 5.1 with a caustic blend of potassium hydroxide and sodium hydroxide. The slurry is then diluted with water to a concentration of 4.2% solids, and is washed in a bowl centrifuge. Two hundred and seventy-five pounds of the washed concentrated cake adjusted to 14% solid slurry are neutralized with a caustic blend of potassium hydroxide and sodium hydroxide. The contents are then fortified by the addition of eighty pounds of a 3.5% aqueous slurry of Tri calcium Phosphate. The acid phosphatase and phytase are deactivated by jet cooking at 150° C. and flash cooled to 53° C. by ejection into a vacuumized chamber having a pressure of about 26 torr. The heated material is partially hydrolyzed with protease to a level of between 0.5% and 30% DH, depending on the need for the product features. The product is then retreated by jet cooking at 150° C. to inactivate the enzyme and flash cooled to 53° C. by ejection into a vacuumized chamber having a pressure of about 26 torr. The heat treated slurry is then spray dried using indirect fire to recover 15.5 pounds of a low nitrite, purified soy protein isolate having a nitrite content of 2 parts per million, a soy protein content of 86% on a moisture free basis, and a calcium content of 2.7%.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A nutritional formula for feeding human infants comprising isolated soy protein wherein the isolated soy protein has
(a) a degree of hydrolysis of from about 0.5% up to about 30%;
(b) a combination of an inositol-6-phosphate content, an inositol-5-phosphate content, an inositol-4-phosphate content and an inositol-3-phosphate content of less than about 8.0 pmol/g soy protein on a moisture free basis; and
(c) a nitrite content of less than about 10 parts per million.

2. The nutritional formula of claim 1 where the combination of inositol-6-phosphate, inositol-5-phosphate, inositol-4-phosphate and inositol-3-phosphate is less than about 6.0 μmol/g soy protein on a moisture free basis.

3. The nutritional formula of claim 1 where the combination of inositol-6-phosphate, inositol-5-phosphate, inositol-4-phosphate and inositol-3-phosphate is less than about 3.0 μmol/g soy protein on a moisture free basis.

4. The nutritional formula of claim 1 wherein said isolated soy protein has a degree of hydrolysis of from about 5% up to about 20%.

5. The nutritional formula of claim 1, wherein said isolated soy protein has a degree of hydrolysis of from about 10% up to about 15%.

6. The nutritional formula of claim 1 wherein the nitrite level is less than about 8 parts per million.

7. The nutritional formula of claim 1 wherein the nitrite level is less than about 4 parts per million.

8. The nutritional formula of claim 1 further comprising up to about 25% free amino acid on a moisture free basis.

9. The nutritional formula of claim 8 comprising from about 1% up to about 20% on a moisture free basis of a free amino acid content.

10. The nutritional formula of claim 8 comprising from about 3% up to about 15% on a moisture free basis of a free amino acid content.

11. The nutritional formula of claim 1 further comprising a calcium content of from about 1.0% up to about 12%.

12. A method of feeding a human infant comprising administering to the human infant a nutritionally sufficient amount of an infant formula comprising an isolated soy protein wherein the isolated soy protein has
(a) a degree of hydrolysis of from about 0.5% up to about 30%;
(b) a combination of an inositol-6-phosphate content, an inositol-5-phosphate content, an inositol-4-phosphate content and an inositol-3-phosphate content of less than about 8.0 μmol/g soy protein on a moisture free basis; and
(c) a nitrite content of less than about 10 parts per million.

13. The method of claim 12 where the combination of inositol-6-phosphate, inositol-5-phosphate, inositol-4-phosphate and inositol-3-phosphate is less than about 6.0 μmol/g soy protein on a moisture free basis.

14. The method of claim 12 where the combination of inositol-6-phosphate, inositol-5-phosphate, inositol-4-phosphate and inositol-3-phosphate is less than about 3.0 μmol/g soy protein on a moisture free basis.

15. The method of claim 12 wherein said isolated soy protein has a degree of hydrolysis of from about 5% up to about 20%.

16. The method of claim 12, wherein said isolated soy protein has a degree of hydrolysis of from about 10% up to about 15%.

17. The method of claim 12 wherein the nitrite level is less than about 8 parts per million.

18. The method of claim 12 wherein the nitrite level is less than about 4 parts per million.

19. The method of claim 12 further comprising up to about 25% free amino acid on a moisture free basis.

20. The method of claim 19 wherein the free amino acid content is from about 1% up to about 20% on a moisture free basis.

21. The method of claim 19 wherein the free amino acid content is from about 3% up to about 15% on a moisture free basis.

22. The nutritional formula of claim 12 further comprising a calcium content of from about 1.0% up to about 12%.
